(19) United States
(12) Patent Application Publication
(10) Pub. No.: US 2026/0091705 A1
(43) Pub. Date: Apr. 2, 2026

(54) ENERGY STORAGE APPARATUS AND CONTROL METHOD FOR CURRENT INTERRUPTION DEVICE

(71) Applicant: GS Yuasa International Ltd., Kyoto-shi, Kyoto (JP)

(72) Inventor: Atsushi FUKUSHIMA, Kyoto (JP)

(21) Appl. No.: 19/110,717

(22) PCT Filed: Sep. 8, 2023
(86) PCT No.: PCT/JP2023/032819

§ 371 Date: Mar. 11, 2025

(30) Foreign Application Priority Data
Sep. 14, 2022 (JP) 2022-146154

(51) Int. Cl. B60L 58/10; H01M 10/42; H01M 50/249; H01M 50/574

(52) U.S. Cl. CPC B60L 58/10; H01M 10/425; H01M 50/249; H01M 50/574; B60L 2240/12; B60L 2240/60; H01M 2220/20

(57) ABSTRACT

An energy storage apparatus 50 for a vehicle includes a cell 60, a current interruption device 53 which interrupts current of the cell 60, and a management device 120. When an abnormality of the cell 60 is detected while a vehicle 10 is traveling, the management device 120 changes control of the current interruption device 53 in accordance with a difference in state of the traveling vehicle 10.

### TECHNICAL FIELD

The present invention relates to control of a current interruption device.

### BACKGROUND ART

An energy storage apparatus for starting or for auxiliary machine, which is mounted in a vehicle, may include a current interruption device such as a relay, as one of protection devices. Patent Literature 1 discloses an energy storage apparatus including a current interruption device. Patent Literature 2 discloses a battery control apparatus that controls a battery of a vehicle.

The battery control apparatus in Patent Literature 2 includes: a detection unit that detects a type of failure occurring in a battery; an assessment unit that assesses whether or not a vehicle is near a stop spot or whether or not a travel distance of the vehicle from start-up to stop of the vehicle is equal to or less than a threshold value; and a control unit. When the assessment unit assesses that the vehicle is near the stop spot or when it is assessed that a travel distance of the vehicle from start-up to stop of the vehicle is equal to or less than the threshold value, the control unit limits the input power or the output power according to a type of failure detected by the detection unit in such a way that the vehicle is allowed to travel. When the assessment unit assesses that the vehicle is not near the stop spot or when it is assessed that a travel distance of the vehicle from start-up to stop of the vehicle is longer than the threshold value, the control unit limits the input power or the output power according to a type of failure detected by the detection unit.

### CITATION LIST

### Patent Literature

Patent Literature 1: Japanese Unexamined Patent Application Publication No. 2017-5985
Patent Literature 2: Japanese Unexamined Patent Application Publication No. 2021-72680

### DISCLOSURE OF INVENTION

### Problems to be Solved by the Invention

When an abnormality such as overcharge or overcurrent occurs, a vehicle can cut off current by opening a built-in current interruption device, thereby protecting an energy storage apparatus for a vehicle. However, when the current interruption device is opened during traveling of the vehicle, power supply to a load (at least a traveling system and an auxiliary system) of the vehicle may stop.

The necessity for maintaining a power supply in a vehicle during traveling varies depending on a difference in travel area, traveling speed, or the like. Up to this point, when a battery abnormality is detected while a vehicle is traveling, controlling a current interruption device in consideration of a balance between battery protection and priority of power supply to the vehicle has not been studied, and there has been room for improvement.

The present inventor has completed the invention by overcoming the above-described problems.

### Means for Solving the Problems

An energy storage apparatus for a vehicle includes a cell, a current interruption device that interrupts current of the cell, and a management device.

When an abnormality of the energy storage apparatus is detected while a vehicle is traveling, the management device changes control of the current interruption device depending on a state of the traveling vehicle.

The present technology can be applied to a control method and a control program of a current interruption device.

### Effect of the Invention

The present technology can control the current interruption device in consideration of a balance between battery protection and priority of power supply to a vehicle, by changing control of the current interruption device depending on a state of the traveling vehicle when an abnormality occurs in the energy storage apparatus. Therefore, it is possible to take actions according to the situation, such as stopping the vehicle while giving priority to protecting the battery as much as possible, or prioritizing safe evacuation of the vehicle by considering the vehicle's situation rather than protecting the battery.

### BRIEF DESCRIPTION OF DRAWINGS

FIG. 1 is a side view illustrating a vehicle.

FIG. 2 is an exploded perspective view of an energy storage apparatus.

FIG. 3 is a sectional view of a cell.

FIG. 4 is a plan view of the cell.

FIG. 5 is a block diagram illustrating an electrical configuration of the vehicle.

FIG. 6 is a diagram illustrating a distance to a destination and a remaining time.

FIG. 7 is a flowchart of optimal control of a current interruption device.

FIG. 8 is a flowchart of optimal control of a current interruption device.

FIG. 9 is a diagram illustrating a voltage range of an energy storage apparatus.

### DESCRIPTION OF EMBODIMENTS

An outline of an energy storage apparatus for a vehicle will be described.

(1) An energy storage apparatus according to an embodiment of the present invention includes: a cell; a current interruption device that interrupts current of the cell; and a management device.

When an abnormality of the energy storage apparatus is detected while a vehicle is traveling, the management device changes control of the current interruption device depending on a state of the traveling vehicle.

The energy storage apparatus according to an embodiment of the present invention changes, when an abnormality occurs in the energy storage apparatus, control of the current interruption device depending on a difference in the state of a traveling vehicle, thereby allowing control of the current interruption device in consideration of a balance between battery protection and priority of power supply to the vehicle.

(2) In the energy storage apparatus described in the above (1), the state of the vehicle may be a travel area of the vehicle.

According to the energy storage apparatus described in the above (2), when the vehicle is stopped or is traveling in a place where it is difficult to park the vehicle, it is possible to perform control such as prioritizing power supply to the vehicle over battery protection.

(3) In the energy storage apparatus described in the above (1), the state of the vehicle may be a traveling speed of the vehicle.

According to the energy storage apparatus described in the above (3), when the traveling speed of the vehicle is high and it takes time to stop or park the vehicle, control can be performed such that power supply to the vehicle is prioritized over battery protection.

(4) In the energy storage apparatus described in the above (1), the state of the vehicle may be a difference between presence and absence of reception of disaster information.

According to the energy storage apparatus described in the above (4), it is possible to perform control such that power supply to the vehicle is prioritized over battery protection when disaster information has been received and the emergency level is high.

(5) In the energy storage apparatus described in any one of the above (1) to (4), the management device may change a closed state maintaining time of the current interruption device depending on the state of the vehicle.

According to the energy storage apparatus described in the above (5), after an abnormality of the energy storage apparatus is detected, a time during which power is supplied from the energy storage apparatus to the vehicle can be optimized depending on a difference in the state of the vehicle.

### First Embodiment

### 1. Configuration of Vehicle 10

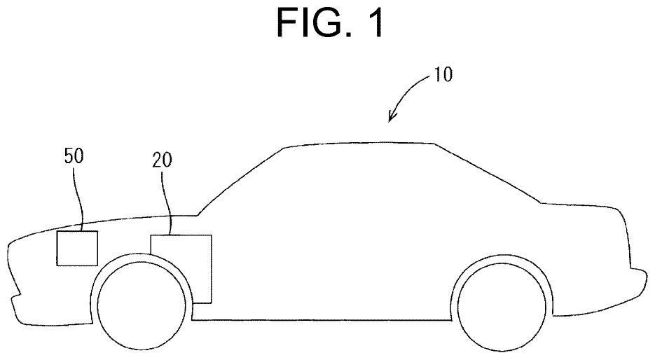

FIG. 1 is a side view of a vehicle. A vehicle 10 includes an engine 20 as a power means. FIG. 1 illustrates only an engine 20 and an energy storage apparatus 50 mounted in the vehicle 10, and other components constituting the vehicle 10 are omitted.

The energy storage apparatus 50 mounted in the vehicle 10 is for starting engine or auxiliary machine, and is a rated 12 V in this embodiment. The vehicle 10 may be mounted with a drive motor for driving and an energy storage apparatus, in addition to or instead of the engine 20 (internal combustion engine).

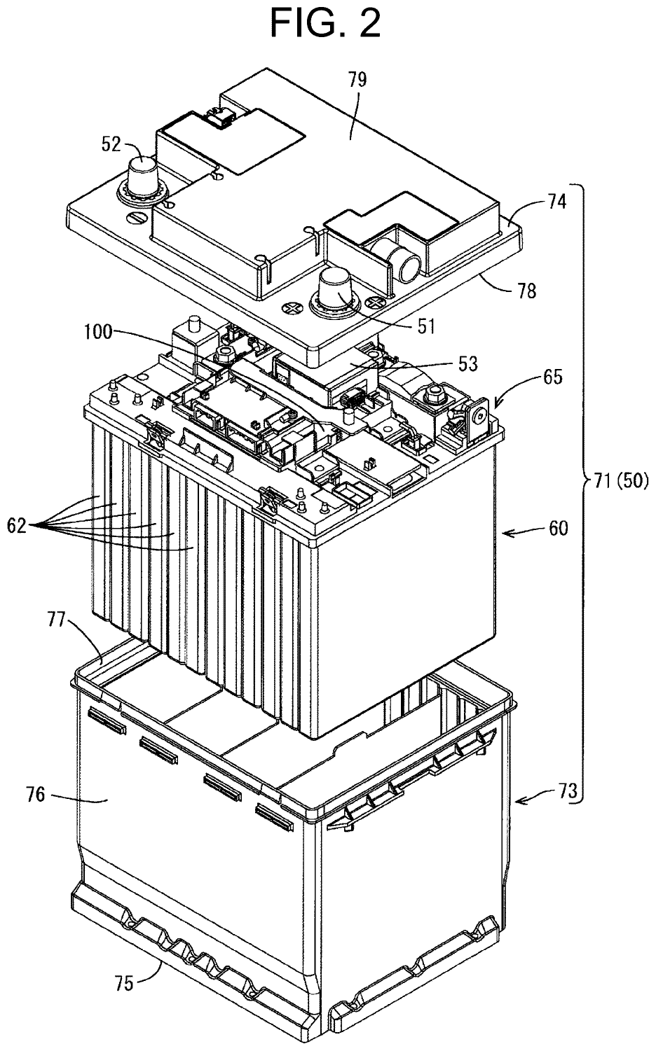

As illustrated in FIG. 2, the energy storage apparatus 50 includes a battery pack 60, a monitoring board 100, and an accommodation body 71.

The accommodation body 71 includes a main body 73 and a lid body 74. The main body 73 and the lid body 74 are made of synthetic resin. The main body 73 has a cylindrical shape with a bottom. The main body 73 includes a bottom surface portion 75 and four side surface portions 76. The four side surface portions 76 form an opening portion 77 at an upper end of the main body 73.

The accommodation body 71 accommodates therein the battery pack 60 and the monitoring board 100. The monitoring board 100 includes various components (a current interruption device 53, a voltage detector 110 and a management device 120 illustrated in FIG. 4, and the like) mounted on a printed board. As illustrated in FIG. 2, the monitoring board 100 is disposed, for example, above and adjacent to the battery pack 60. Alternatively, the monitoring board 100 may be disposed adjacent to a side of the battery pack 60.

The lid body 74 closes the opening portion 77 of the main body 73. An outer peripheral wall 78 is provided around the lid body 74. The lid body 74 has a protruding portion 79 that is substantially T-shaped in plan view. A positive electrode external terminal 51 is fixed to one corner portion of a front portion of the lid body 74, and a negative electrode external terminal 52 is fixed to the other corner portion of the front portion of the lid body 74. The monitoring board 100 may be accommodated in the lid body 74 (for example, in the protruding portion 79) instead of the main body 73 of the accommodation body 71.

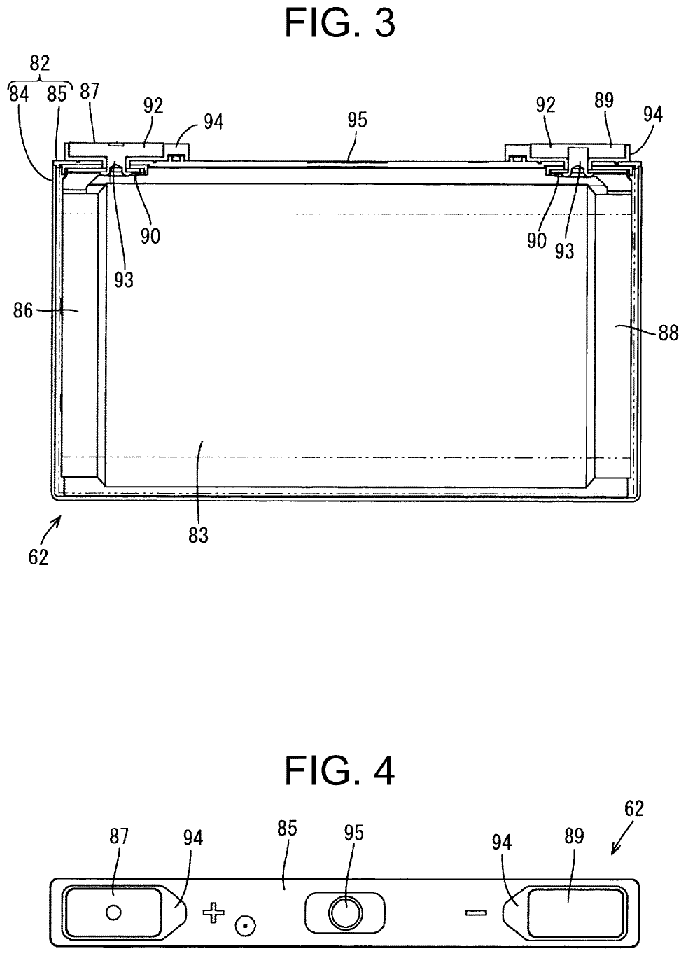

The battery pack 60 includes a plurality of cells 62. As illustrated in FIG. 3, the cell 62 accommodates an electrode body 83 in a rectangular parallelepiped case 82 together with a non-aqueous electrolyte. The cell 62 is, for example, a lithium-ion secondary battery cell. The case 82 includes a case main-body 84 and a lid 85 that closes an opening portion above the case main-body 84.

Although not illustrated in detail, the electrode body 83 includes a separator made of a porous resin film disposed between a negative electrode plate obtained by applying an active material to a base material made of copper foil and a positive electrode plate obtained by applying an active material to a base material made of aluminum foil.

Each of these has a band shape, and is wound into a flat shape in a state in which the negative electrode plate and the positive electrode plate are shifted in positions opposite to each other in the widthwise direction with respect to the separator. The electrode body 83 may be of a laminated type instead of a wound type.

A positive electrode terminal 87 is connected to the positive electrode plate via a positive electrode current collector 86, and a negative electrode terminal 89 is connected to the negative electrode plate via a negative electrode current collector 88. The positive electrode current collector 86 and the negative electrode current collector 88 each include a pedestal portion 90 having a flat plate shape, and a leg portion extending from the pedestal portion 90. A through hole is formed in the pedestal portion 90.

Each of the positive electrode terminal 87 and the negative electrode terminal 89 is configured from a terminal main-body portion 92 and a shaft portion 93 protruding downward from a central part of a lower surface of the terminal main-body portion 92. The terminal main-body portion 92 and the shaft portion 93 of the positive electrode terminal 87 are integrally formed of aluminum (a single material). In the negative electrode terminal 89, the terminal main-body portion 92 is made of aluminum, the shaft portion 93 is made of copper, and these are assembled. The terminal main-body portions 92 of the positive electrode terminal 87 and the negative electrode terminal 89 are disposed at both end portions of the lid 85 via gaskets 94 made of an insulating material, and are exposed outward from the gaskets 94, as illustrated in FIG. 4.

The lid 85 includes a pressure release valve (safety valve) 95. The pressure release valve 95 is positioned between the positive electrode terminal 87 and the negative electrode terminal 89. When the internal pressure of the case 82 exceeds a limit, the pressure release valve 95 is opened to lower the internal pressure of the case 82.

### 2. Electrical Configuration (Power Source System) of Vehicle 10

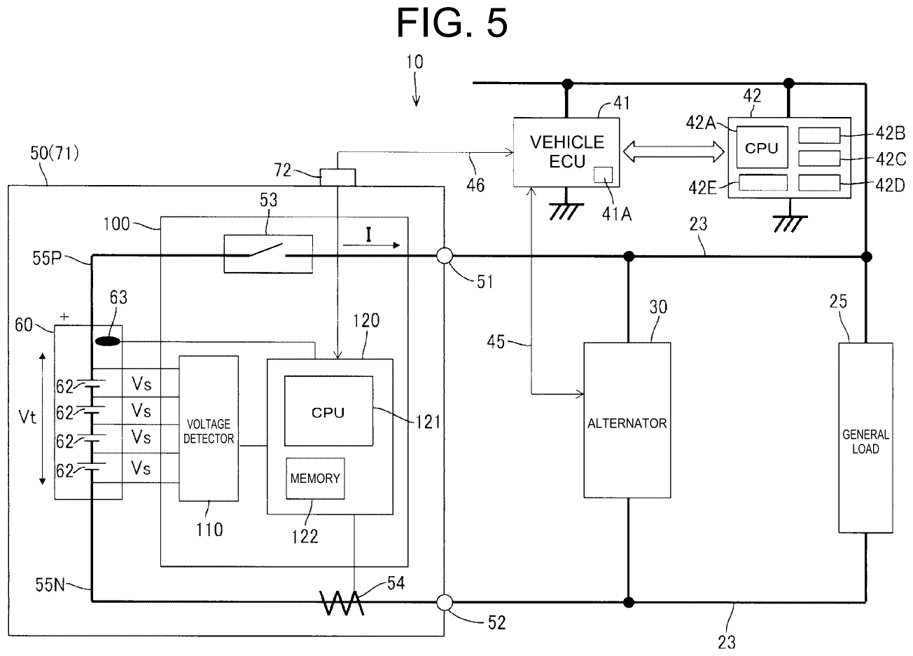

As illustrated in FIG. 5, the vehicle 10 includes a general electric load 25, an alternator 30, a vehicle ECU 41, a car navigation apparatus 42, and an energy storage apparatus 50.

The general load 25 may be an engine starter or auxiliary machinery. The engine starter includes a motor to start the engine. The auxiliary machinery includes a headlight, an electric power steering, an air conditioner, a power window, and the like.

A vehicle electronic control unit (ECU) 41 is connected to the alternator 30 via a communication line 45, and is connected to be communicable with the energy storage apparatus 50 via a communication line 46. A reference numeral 72 illustrated in FIG. 5 is a connector for connecting the communication line 46.

The vehicle ECU 41 controls charging and discharging of the energy storage apparatus 50 mounted in the vehicle 10. In addition to the charge/discharge control, the vehicle ECU 41 notifies the energy storage apparatus 50 of various kinds of information such as information regarding a state of the traveling vehicle 10, by communication via the communication line 46.

The energy storage apparatus 50 includes a current interruption device 53, a battery pack 60, a current detector 54, a voltage detector 110, a management device 120, and a temperature sensor 63.

The current interruption device 53, the voltage detector 110, and the management device 120 are mounted on the monitoring board 100.

The battery pack 60 has, for example, twelve cells 62 (refer to FIG. 2), and the cells 62 are connected three in parallel and four in series. In FIG. 5, the three cells 62 connected in parallel are represented by one battery symbol. The cell is an energy storage cell which can be repeatedly charged and discharged. The cell is not limited to a rectangular parallelepiped cell, and may be a cylindrical cell or a pouch cell having a laminate film case.

The positive electrode of the battery pack 60 is connected to the positive electrode external terminal 51 via a power line 55P. The negative electrode of the battery pack 60 is connected to the negative electrode external terminal 52 via a power line 55N.

The external terminals 51 and 52 are terminals for connection to the general load 25, the alternator 30, the vehicle ECU 41, and the car navigation apparatus 42, which are mounted in the vehicle 10.

The current interruption device 53 is positioned at a positive electrode of the battery pack 60, and is provided in the power line 55P of the positive electrode. The current interruption device 53 can use a switch having a mechanical contact, such as a relay. In addition to the mechanical contact, a semiconductor switch such as an FET can be used.

The current interruption device 53 is controlled to be in a closed state during normal operation. When there is an abnormality in the energy storage apparatus 50, the management device 120 outputs a control signal to the current interruption device 53 and opens the current interruption device 53. By opening the current interruption device 53, current I can be interrupted and the energy storage apparatus 50 can be protected. Examples of the abnormality in the energy storage apparatus 50 include overvoltage, overcurrent, overcharge, and overdischarge. The abnormality referred to herein includes not only an abnormality of a cell but also a failure in which the energy storage apparatus 50 does not operate normally, such as a failure of a switch, and includes a single failure and a composite failure.

The current detector 54 detects current I [A] of the battery pack 60. The current detector 54 may be a shunt resistor. The resistive current detector 54 can measure the current I of the battery pack 60, based on a voltage between both ends of the current detector 54. The resistive current detector 54 can distinguish between discharging and charging, based on the voltage polarity (positive or negative). Alternatively, the current detector 54 may be a magnetic sensor.

The voltage detector 110 is connected to both ends of each cell 62 via a signal line, and measures a cell voltage Vs of each cell 62. Further, a total voltage Vt of the battery pack 60 is measured from the cell voltage Vs of each cell 62. The total voltage Vt of the battery pack 60 is a total voltage of the four cells 62 connected in series. The temperature sensor 63 is attached to the battery pack 60, and detects a temperature of the battery pack 60.

The management device 120 includes a CPU 121 having an arithmetic function and a memory 122 which is a storage unit. The management device 120 monitors a temperature T, the current I, and the total voltage Vt of the battery pack 60, based on the outputs of the current detector 54, the voltage detector 110, and the temperature sensor 63.

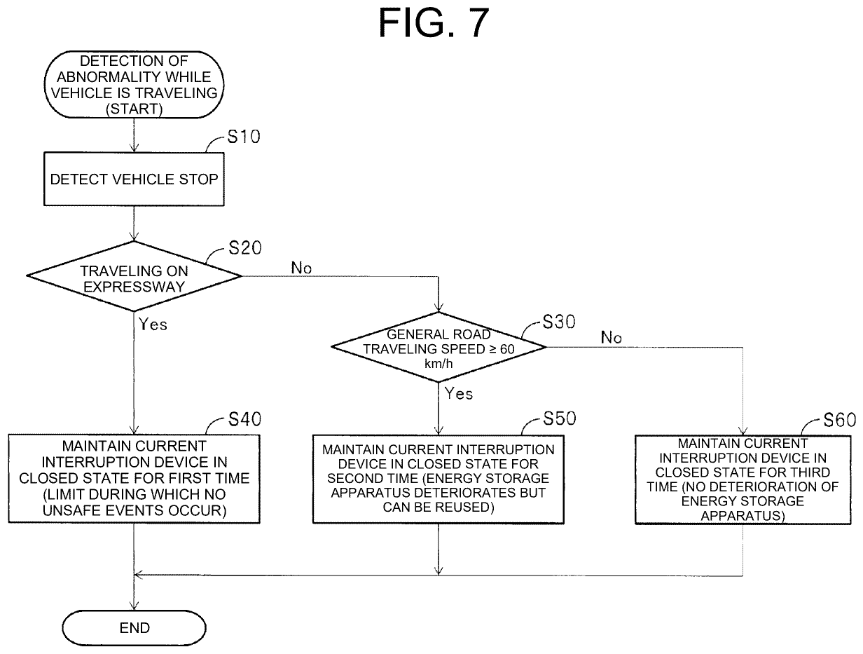

The memory 122 is a non-volatile storage medium such as a flash memory or an EEPROM. The memory 122 stores a monitoring program for monitoring a state of the battery pack 60 and data necessary for executing the monitoring program. Further, the memory 122 stores a control program (an execution program of a flowchart illustrated in FIG. 7) of the current interruption device 53 and data necessary for executing the control program.

The program may be stored by using a telecommunication line.

The car navigation apparatus 42 includes a CPU 42A, a data storage portion 42B, a first reception portion 42C, a second reception portion 42D, and a display panel 42E. The data storage portion 42B stores map information. The first reception portion 42C receives GPS information (position information of the vehicle 10) from a GPS satellite. The second reception portion 42D receives road information from an information service center.

A user of the vehicle can input a destination G of the vehicle 10 by a panel operation on the display panel 42E. The car navigation apparatus 42 searches for a route to the destination G by using the map information in the data storage portion 42B, and displays a search result on the display panel 42E.

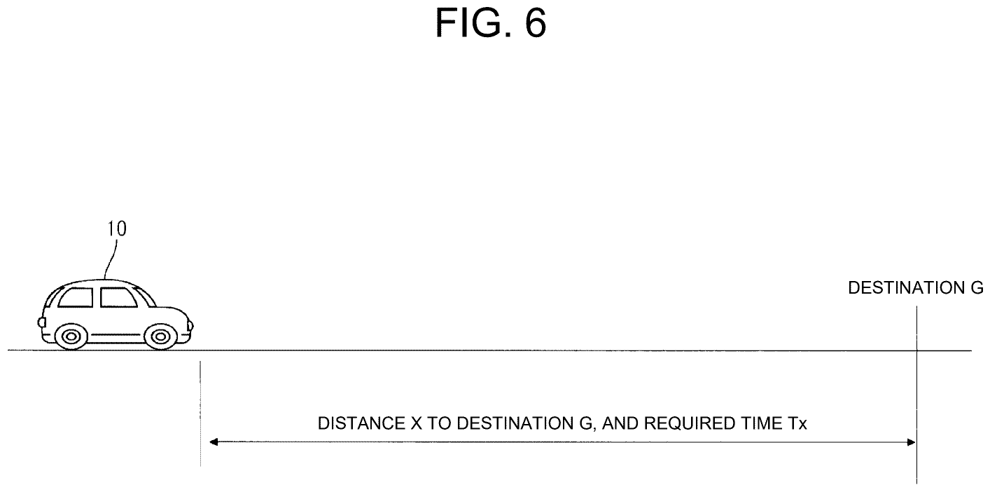

The car navigation apparatus 42 acquires the position information, the traveling speed, and traffic information of the vehicle 10, based on information received by the first reception portion 42C and the second reception portion 42D during traveling. The car navigation apparatus 42 calculates a distance X from the current place to the destination G and a required time Tx to the destination G in real time, based on a measurement value of a gyro sensor provided in the vehicle 10 (a measurement value of the position information of the vehicle 10) and a measurement value of a vehicle speed pulse sensor provided in the vehicle 10 (a measurement value of speed information of the vehicle 10), with reference to these pieces of information (refer to FIG. 6). The calculation result is displayed on the display panel 42E.

### 2. Optimal Control of Current Interruption Device

The management device 120 monitors the state of the energy storage apparatus 50, based on the current, the voltage, the cell voltage, and the temperature of the energy storage apparatus 50 while the vehicle is traveling. When an abnormality of the energy storage apparatus 50 is detected while the vehicle is traveling, the management device 120 performs optimal control of the current interruption device 53. The optimal control is to optimize the control of the current interruption device 53 according to a difference in state of the traveling vehicle 10, and includes six steps of S10 to S60, as illustrated in FIG. 7.

When an abnormality of the energy storage apparatus 50 is detected while the vehicle 10 is traveling, first, the management device 120 notifies the vehicle ECU 41 to request that the vehicle 10 stops traveling due to occurrence of the abnormality (S10). Further, the management device 120 acquires the following information (1) from the car navigation apparatus 42 via the vehicle ECU 41, and acquires the following information (2) from the vehicle ECU 41, together with the notification requesting stop.

### (1) Information on the Travel Area of the Vehicle 10

### (2) Information on the Traveling Speed of the Vehicle 10

Thereafter, the management device 120 determines whether the travel area of the vehicle 10 is an expressway, based on the information on the travel area acquired from the car navigation apparatus 42 (S20).

When the vehicle 10 is traveling on an expressway (S20: YES), the management device 120 transmits a signal to the current interruption device 53, and the current interruption device 53 is maintained in the closed state during a first time T1 and is opened after the first time T1 elapses (S40). The first time T1 is assumed in advance to be a limited time period during which an unsafe event occurs in the energy storage apparatus 50 if the energy storage apparatus 50 continues to be used after an abnormality occurs, and is two minutes as an example.

In this case, the energy storage apparatus 50 maintains power supply to the vehicle 10 for the first time T1 after the occurrence of the abnormality. Therefore, a driver can use this time to move the vehicle 10 during traveling on the expressway to an emergency stop area such as an emergency parking zone.

Next, when the vehicle 10 is traveling on an ordinary road (S20: NO), the management device 120 determines whether the traveling speed of the vehicle 10 is equal to or higher than a predetermined value (60 km/h as an example) (S30).

When the traveling speed of the vehicle 10 is equal to or higher than the predetermined value (S30: YES), the management device 120 maintains the current interruption device 53 in the closed state for a second time T2, and opens the current interruption device 53 after the second time T2 elapses (S50). The second time T2 is a time period during which the energy storage apparatus 50 can be reused although the energy storage apparatus 50 deteriorates or is damaged due to continuous use after an abnormality occurs. The second time T2 is shorter than the first time T1 (T1>T2), and is one minute as an example.

In this case, the energy storage apparatus 50 maintains the power supply to the vehicle 10 for the second time T2 after the occurrence of the abnormality. Therefore, the driver can use this time to move the vehicle 10 traveling at a traveling speed equal to or higher than the predetermined value to a safe place near an ordinary road.

When the traveling speed of the vehicle 10 is less than the predetermined value (S30: YES), the management device 120 maintains the current interruption device 53 in the closed state for the third time T3, and opens the current interruption device 53 after the third time T3 elapses (S50). The third time T3 is a time period during which the energy storage apparatus 50 does not deteriorate or is damaged even if the energy storage apparatus 50 continues to be used after an abnormality occurs. The third time T3 is shorter than the second time T2 (T2>T3), and is 20 seconds as an example.

In this case, the energy storage apparatus 50 maintains the power supply to the vehicle 10 for the third time T3 after the occurrence of the abnormality. Therefore, the driver can use the time to move the vehicle 10, which is traveling at a traveling speed less than the predetermined value, to a safe place near an ordinary road.

In this embodiment, a difference is set in the closed state maintaining time of the current interruption device 53 according to a difference in the travel area or traveling speed of the vehicle 10, and the reason therefor is as follows.

The reason why a difference is set in the closed state maintaining time of the current interruption device 53 according to the travel area of the vehicle 10 is that a time required from when the driver receives a notification of abnormality until when the vehicle 10 stops varies depending on the travel area. In short, when it takes time to stop the vehicle at a safe place, for example, while the vehicle is traveling on an expressway, the vehicle traveling on the expressway can be moved to the safe place and stopped by lengthening the closed state maintaining time. On the other hand, when there is a possibility that the energy storage apparatus 50 can stop in a short time during traveling, such as during traveling on an ordinary road, deterioration or damage of the energy storage apparatus 50 can be suppressed by shortening the closed state maintaining time.

The reason why a difference is set in the closed state maintaining time of the current interruption device 53 according to a difference in the traveling speed of the vehicle 10 is also the same, and this is because the time required from when the driver receives a notification of an abnormality until when the vehicle 10 during traveling stops varies depending on the traveling speed of the vehicle 10.

In short, when the traveling speed of the vehicle 10 is high and it takes time to stop the vehicle 10 from traveling, the closed state maintaining time is lengthened, whereby the vehicle 10 having a high traveling speed can be safely stopped. On the other hand, when the traveling speed is low and it is possible to stop the vehicle in a short time from traveling, the closed state maintaining time is shortened, whereby deterioration or damage of the energy storage apparatus 50 can be suppressed as much as possible.

### 3. Explanation of Effects

With this configuration, control of the current interruption device 53 at the time of occurrence of an abnormality is changed depending on a travel area or a traveling speed of the vehicle 10. Therefore, the current interruption device 53 can be controlled (optimized) in consideration of a balance between the protection of the energy storage apparatus 50 and the priority of power supply to the vehicle 10. Accordingly, the vehicle 10 can be caused to perform evacuation traveling to a safe place, and deterioration or damage of the energy storage apparatus 50 can be minimized.

### Second Embodiment

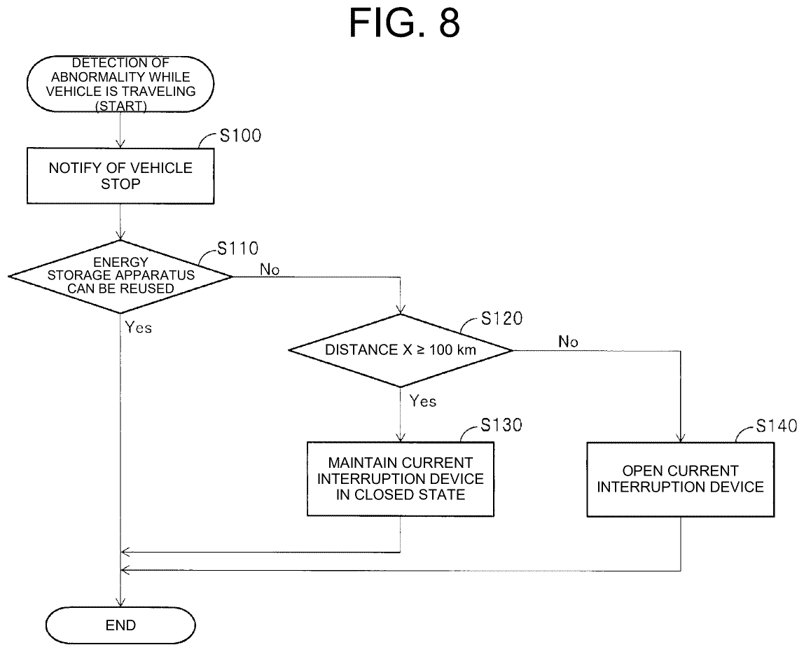

A second embodiment is different from the first embodiment in optimal control of the current interruption device 53. The optimal control according to the second embodiment is executed when the management device 120 detects an abnormality in the energy storage apparatus 50 while the vehicle 10 is traveling, and includes five steps of S100 to S140, as illustrated in FIG. 8.

When an abnormality in the energy storage apparatus 50 is detected while the vehicle 10 is traveling, the management device 120 first notifies a vehicle ECU 41 to request that the vehicle 10 stops traveling due to occurrence of the abnormality.

Thereafter, the management device 120 determines whether the energy storage apparatus 50 in which an abnormality has occurred can be reused (S110). Whether or not the energy storage apparatus 50 can be reused can be determined based on the voltage of the energy storage apparatus 50.

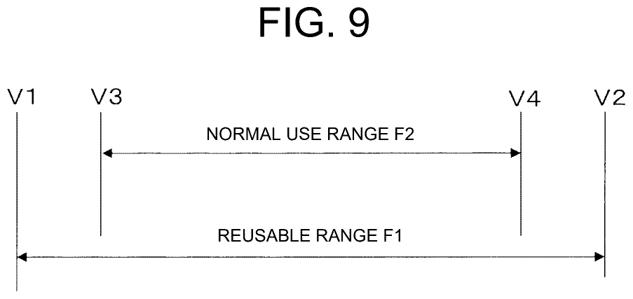

For example, whether or not the energy storage apparatus 50 is reusable can be determined by comparing a total voltage Vt of the energy storage apparatus 50 with a reusable range F1 (refer to FIG. 9). In an example of FIG. 9, the reusable range F1 is wider than a normal use range F2. When the energy storage apparatus 50 is out of the normal use range, it is determined to be abnormal, and when the energy storage apparatus 50 is further out of the reusable range, it is determined to be non-reusable. Whether or not the energy storage apparatus 50 can be reused can be determined not only by the voltage but also by a temperature or a current value of the energy storage apparatus 50.

When the management device 120 determines that the energy storage apparatus 50 is reusable (S110: YES), the management device 120 does not open the current interruption device 53, but maintains the current interruption device 53 in the closed state.

In this case, since the power supply from the energy storage apparatus 50 to the vehicle 10 is maintained even after the abnormality has occurred, a driver can stop or park the vehicle 10 after moving the vehicle 10 to a safe place.

When the management device 120 determines that the energy storage apparatus 50 cannot be reused (S110: NO), the management device 120 determines whether a distance X from the current location to the service base is equal to or larger than a predetermined value (100 km as an example) (S120).

The service base is a base at which some service such as refueling or maintenance is performed on the vehicle 10, and is, for example, a gas station or a dealer of the vehicle 10. The distance X to the service base is obtained by the management device 120 causing the car navigation apparatus 42 to calculate the distance from the current location to the closest service base via the vehicle ECU 41, and acquiring a calculation result from the car navigation apparatus 42.

When the distance X to the service base is equal to or larger than the predetermined value (S120: YES), the management device 120 prioritizes safety of the vehicle 10 and maintains the current interruption device 53 in the closed state (S130).

In this case, since the power supply from the energy storage apparatus 50 to the vehicle 10 is maintained even after the abnormality has occurred, the driver can move the vehicle 10 to the service base.

When the distance X to the service base is less than the predetermined value (S120: NO), the management device 120 prioritizes reuse of the energy storage apparatus 50, and switches the current interruption device 53 from the closed state to an open state (S140).

In this case, after the abnormality has occurred, power supply from the energy storage apparatus 50 to the vehicle 10 is interrupted, and therefore, it is difficult for the vehicle 10 to continue traveling. After an emergency stop of the vehicle 10 nearby, the driver contacts a business operator who provides road service, and requests support.

In the first embodiment, when the management device 120 detects an abnormality in the energy storage apparatus 50 while the vehicle 10 is traveling, the management device 120 changes the closed state maintaining time of the current interruption device 53 depending on the travel area and traveling speed of the vehicle 10.

On the other hand, in the second embodiment, the management device 120 switches between control to open the current interruption device 53 and control to close the current interruption device 53, depending on the distance X from the current location to the nearest service base. In the second embodiment, similarly to the first embodiment, the management device 120 can control (optimize) protection of the energy storage apparatus and power supply to the vehicle 10 while keeping a balance therebetween.

### Other Embodiments

The present invention is not limited to the embodiments explained with reference to the above description and the drawings, and the technical scope of the present invention also incorporates the following embodiments.

(1) The cell (repeatedly chargeable and dischargeable energy storage cell) 62 is not limited to a lithium ion secondary battery cell, and may be an other non-aqueous electrolyte secondary battery cell. Instead of the secondary battery cell 62, a capacitor can be used.

(2) In the first embodiment, the management device 120 changes the control of the current interruption device 53 between a case where the vehicle 10 is traveling on an expressway and a case where the vehicle 10 is traveling on an ordinary road. In addition, the management device 120 may change the control of the current interruption device 53 between a case where the vehicle 10 is traveling in a place where stopping is difficult, such as an intersection or a railroad crossing, and a case where the vehicle 10 is traveling in a place other than that.

In short, the management device 120 may set a closed state maintaining time of the current interruption device 53 to be long in a place where stopping is difficult, such as an intersection or a railroad crossing, and may set the closed state maintaining time of the current interruption device 53 to be short when traveling in other places.

(3) In the above-described second embodiment, when the management device 120 detects an abnormality in the energy storage apparatus 50 during traveling, the management device 120 changes the control of the current interruption device 53 depending on the distance X from the current location of the vehicle 10 to the nearest service base. In addition to this, the management device 120 may change the control of the current interruption device 53 depending on whether or not disaster information of the vehicle 10 is received. Specifically, when the vehicle 10 during traveling receives disaster information, even if the management device 120 detects an abnormality in the energy storage apparatus 50, the management device 120 prioritizes moving to a safe place, and does not switch the current interruption device 53 to an open state (maintains the closed state). On the other hand, when the vehicle 10 has not received the disaster information, the management device 120 prioritizes reuse of the energy storage apparatus 50, and switches the current interruption device 53 from closed to open.

The disaster information includes typhoon information, earthquake information, tsunami information, flood information, and the like.

The vehicle 10 can acquire disaster information from an information providing center or the like via the navigation apparatus 42. Note that, in the embodiments, the processing performed by the management device 120 has been described, but the same processing may be performed by a vehicle ECU 41, or a server outside the vehicle may remotely perform the processing by exchanging necessary information with the vehicle.

Further, in the embodiments, a case in which the present technology is applied to an automobile has been described, but the present technology is not limited thereto, and can also be applied to a motorcycle or a railway vehicle for safe traveling and operation. The present technology can also be applied to navigation of a ship and operation of a flying object. In other words, the present technology can be implemented in the following forms.
(A) An energy storage apparatus for a mobile object, the energy storage apparatus including: a cell; a current interruption device which interrupts current of the cell; and a management device, in which when an abnormality in the energy storage apparatus is detected while a mobile object is moving, the management device changes control of the current interruption device depending on a state of the mobile object in motion.
(B) The state of the mobile object may be a moving path of the mobile object or a moving speed of the mobile object.
(C) The state of the mobile object may be a difference between presence and absence of reception of disaster information.
(D) The management device may change a closed state maintaining time of the current interruption device depending on the state of the mobile object.

### DESCRIPTION OF REFERENCE NUMERALS

10 Vehicle
41 Vehicle ECU
50 Energy storage apparatus
53 Current interruption device
60 Battery pack
120 Management device

1. An energy storage apparatus for a vehicle, the energy storage apparatus comprising:
a cell;
a current interruption device that interrupts current of the cell; and
a management device, wherein,
when an abnormality of the energy storage apparatus is detected while the vehicle is traveling, the management device changes control of the current interruption device depending on a state of the traveling vehicle.

2. The energy storage apparatus according to claim 1, wherein
the state of the vehicle is a travel area of the vehicle or a traveling speed of the vehicle.

3. The energy storage apparatus according to claim 1, wherein
the state of the vehicle is a difference between presence and absence of reception of disaster information.

4. The energy storage apparatus according to claim 1, wherein
the management device changes a closed state maintaining time of the current interruption device depending on the state of the vehicle.

5. (canceled)

6. A control method for a current interruption device used in an energy storage apparatus for a mobile object, the control method comprising
changing, when an abnormality in the energy storage apparatus is detected while the mobile object is moving, control of the current interruption device depending on a state of the mobile object in motion.

7. An energy storage apparatus for a vehicle, the energy storage apparatus comprising:
a cell;
a current interruption device that interrupts current of the cell; and
a management device, wherein,
when an abnormality of the energy storage apparatus is detected while the vehicle is traveling, the management device changes control of the current interruption device depending on a state of the traveling vehicle,
the state of the vehicle is a travel area of the vehicle or a traveling speed of the vehicle, and
the management device changes a closed state maintaining time of the current interruption device depending on the state of the vehicle.
